(19) United States
(12) Patent Application Publication
(10) Pub. No.: US 2009/0040922 A1
(43) Pub. Date: Feb. 12, 2009

(54) EFFICIENT PROTECTION MECHANISMS IN A RING TOPOLOGY NETWORK UTILIZING LABEL SWITCHING PROTOCOLS

(76) Inventors: Igor Umansky, Petach Tikva (IL); Gilad Goren, Nirit (IL)

Correspondence Address: SUGHRUE MION, PLLC, 2100 PENNSYLVANIA AVENUE, N.W., SUITE 800, WASHINGTON, DC, 20037, US

(21) Appl. No.: 11/568,597

(22) PCT Filed: May 3, 2005
(86) PCT No.: PCT/IL05/00464

§ 371 Date: Dec. 27, 2006

(51) Int. Cl. H04L 12/24

(52) U.S. Cl. 370/224

(57) ABSTRACT

Efficient protection mechanisms for ring based label-switching networks are designed to protect point-to-point label switching paths (LSPs) while preventing misconnection and mismerge situations. The protection switching is performed by nodes adjacent to the point of failure. The switching decision is based on a locally detected signal fail condition. The operation of the protection mechanisms does not require the use of any protection switching protocol. In one embodiment of the present invention, the protection is achieved by assigning an exclusive label to each LSP. In another embodiment, the protection is achieved by providing a closed-loop protection tunnel and assigning a tunnel label for each such protection tunnel. In yet another embodiment, the protection is achieved by establishing a mirror path for each protected LSP.

### FIELD OF THE INVENTION

The present invention relates generally to label switching communication networks, and more particularly to methods and systems for providing failure protection in a ring topology network (RTP) that utilizes label switching protocols.

### BACKGROUND OF THE INVENTION

The label switching technique was developed in switching networks to expedite the look-up process at each network node as packets travel from a source node to a destination node. Abstractly, label switching involves attaching to a packet a label that enables an intermediate network node (“hop”) that receives the packet to quickly determine the next node of the packet. An example for such label switching protocol is the multi-protocol label switching (MPLS).

In a MPLS network, a label is assigned to each incoming packet by a label edge router (LER). Packets are forwarded along a label switch path (LSP) in which each label switch router (LSR) makes forwarding decisions based solely on the contents of the label. At each hop (or intermediate node), the LSR may change the label to a new label that instructs the next LSR how to further forward the packet. LSPs are established by network operators for a variety of purposes, including for guaranteeing a certain level of performance or for routing packets around network congestions.

Ring topology networks are being adapted to carry packet-switched traffic, and label switching is being implemented on the ring networks to provide improved quality of service (QoS) and improved reliability. RTPs in which traffic is transmitted in two directions are commonly used in order to maintain transmission in an event of a failure. Specifically, transmissions occur in one direction in a working path and in an opposite direction in a protection path.

FIG. 1A-B shows an exemplary diagram of a fiber optic ring network 100. Network 100 includes six nodes (e.g., LSRs) 110-1 through 110-6 connected to optical fibers 120 and 130. Fiber 120 transports traffic in a working path and fiber optic 130 occasionally transports traffic in a protection path. Traffic travels on the protection path and the working path in opposite directions. For example, the direction of the working path may be clockwise while the direction of the protection path may be counter-clockwise. Typically, there are two types of optical ring protection networks: unidirectional ring networks and bidirectional ring networks. In a unidirectional ring network, only one fiber (e.g., fiber 120) carries working traffic to be protected while the other fiber (e.g., fiber 130) is dedicated for protecting this traffic. In a bidirectional ring network, each fiber (i.e., fiber 120 or 130) carries both working and protection traffic. The bandwidth of each fiber is divided in such a manner that haft of its bandwidth is dedicated to carrying working traffic and the other half is dedicated to carrying traffic from another fiber in a case of a failure in that fiber. Network 100 may be, for example, a synchronous optical network (SONET), a synchronous digital hierarchy (SDH) network, a resilient packet ring (RPR) network, and the like.

Typically, a fault in network 100 may occur due to a failure of a segment in fiber 120 or a failure of one of nodes 110. In a case of such failures, protection is performed by wrapping traffic from the working path (i.e., fiber 120) to the protection path to bypass the failed node or segment. The term “wrapping” refers to the switching performed on a packet to route it from one path to another.

FIG. 1A shows a LSP ‘Q’ established over network 100 between node 110-1 (which serves as a source node) and node 110-6 (which serves as a destination node) through nodes 110-2 and 110-3. FIG. 1B depicts a failure occurring in a segment of fiber 120 between adjacent nodes 110-2 and 110-3. As the failure is detected, the traffic sent from node 110-1 is wrapped at the node immediately preceding the point of failure (i.e., node 110-2) to the protection path in fiber 130. Traffic carried over the protection path is passed through nodes 110-1, 110-4, 110-5 and 110-6 until traffic reaches the node adjacent to the point of failure from the opposite direction, i.e., node 110-3. At this node, traffic is wrapped back to the working path and directed to destination node 110-6. Generally, no more than 50 milliseconds are necessary for the protection mechanism to switch to protection path following an occurrence of a failure.

The prior art protection techniques just mentioned are further exemplified by the following U.S. patent applications, each of which is incorporated herein by reference for its useful background description of the state of the art heretofore. In US application patent No. 20030108029, Behnam discloses a method and system for providing failure protection in a ring network that utilizes label switching. In the method, a working label switched path (LSP) between neighbor label switched routers (LSRs) in a ring network that utilizes label switching is protected by a LSP that connects the neighbor LSRs of the working LSP in an opposite direction to the working LSP. If the working LSP fails, then packets are switched to the protection LSP. Switched packets traverse the protection LSP until they reach the neighbor LSR that they would have reached had the packets traversed the working LSP. Time-to-live (TTL) values of packets that traverse the protection LSP are adjusted to account for the number of hops on the protection LSP so that the TTL values of the packets are the same after traversing the protection LSP as they would have been had they traversed the working LSP. After traversing the protection LSP packets can be switched back to the working LSP or switched to a next hop LSP. Barshesbet in US patent application 20030043738 teaches a method of fault protection that includes constructing a general mask indicating which of the segments can be reached. For a given data flow to be conveyed through the network from a source node to a destination node, a specific mask is constructed indicating the segments on a desired path of the flow. The general and specific masks are superimposed in order to determine a disposition of the flow.

There are two drawbacks with such prior-art protection techniques, usually referred to “misconnection” and “mismerge”. The misconnection is the case in which traffic transmitted over the protection path and addressed to a failed node is erroneously sent to another node on the ring network, instead of being discarded by one of the nodes along the protection path. The mismerge is the case in which traffic of a first LSP is erroneously combined with traffic that belongs to a second LSP. This may occur if the destination node of the first LSP is the failed node. In either the misconnection or the mismerge cases, the working traffic of LSPs may be lost.

An example for a misconnection is shown in FIG. 2A, where a failed node 210-4 is the source node of LSP ‘Q’ and the destination node of LSP ‘R’. Traffic belonging to LSP ‘R’ is wrapped to the protection path at node 210-5. At node 210-1 the protected traffic of LSP ‘R’ is wrapped to the working path and sent to the destination node 210-3 of LSP ‘Q’. An example for a mismerge is shown in FIG. 2B, where a failed node 210-4 is the source node of LSP ‘Q’ and the destination node of LSP ‘R’. Node 210-1 is the source node of LSP ‘Q’. Traffic belonging to LSP ‘R’ is wrapped to the protection path at node 210-5. At node 210-1 the protected traffic of LSP ‘R’ is merged with the working traffic of LSP ‘Q’ and transmitted to the destination node 210-3 of LSP ‘Q’. In both examples the traffic that belongs to LSP ‘R’ ought to have been discarded.

Therefore, it would be advantageous to provide efficient protection mechanisms for RTPs that are based on label switching protocols. It would be further advantageous if the provided mechanisms would overcome the drawbacks of the protection mechanisms introduced in the prior art without introducing of any type of new fault messaging or protection switching protocols.

### SUMMARY OF THE INVENTION

The present invention discloses efficient protection mechanisms for ring based label-switching networks, in particular MPLS networks. The protection mechanisms are designed to protect point-to-point label switching paths while preventing the misconnection and mismerge situations. The protection switching is performed by nodes adjacent to the point of failure. The switching decision is based on a locally detected signal failure condition. The operation of the disclosed protection mechanisms does not require the use of any protection switching protocol. In the context of the present invention, a node is a network junction or connection point capable of at least processing and wrapping traffic to adjacent nodes.

According to the present invention there is provided in a ring topology network, a first method for protecting a LSP established between a source node and a destination node, the method comprising the steps of assigning an exclusive LSP label for the LSP, configuring each intermediate node in the ring network to transparently pass data packets including the exclusive LSP label, and upon detecting a failure at a network node, switching the data packets including the exclusive LSP label to a protection transport medium using.

According to one feature in the first method of the present invention, the switching of the data packets to the protection transport medium includes wrapping the data packets to the protection transport medium at a first node adjacent to a location of the failure, wherein the method further comprises steps of wrapping the data packets to a working transport medium at a second node adjacent to a location of the failure, and transmitting the wrapped data packets to the destination node.

According to the present invention there is provided in a ring topology network, a second method for protecting a LSP established between a source node and a destination node comprising the steps of creating at least one closed-loop protection tunnel over a protection transport medium, assigning a tunnel label for the protection tunnel, and, upon detecting a failure, switching data packets to the protection tunnel.

According to the present invention there is provided in a ring topology network a third method for protecting a LSP established between a source node and a destination node comprising the steps of creating a mirror protection ring for the LSP over a protection transport medium, and upon detecting a failure, switching the data packets belonging to the LSP to its respective mirror protection ring.

According to the present invention there is provided in a ring topology network comprising a plurality of LSPs established between respective source and destination nodes through at least one respective intermediate node, a LSP protection mechanism comprising an exclusive LSP label assigned to each LSP of the plurality, and a switching mechanism operative to use the exclusive LSP label in order to prevent misconnection and mismerge of data packets.

According to one feature in the LSP protection mechanism of the present invention, the switching mechanism includes a configuration mechanism operative to configure each intermediate node to transparently pass data packets including the exclusive LSP label.

According to the present invention there is provided in a ring communications network comprising a plurality of LSPs established between respective source and destination nodes through at least one respective intermediate node, a LSP protection mechanism comprising at least one protection tunnel established over a protection transport medium, a respective closed-loop tunnel label assigned to each protection tunnel, and a switching mechanism operative to switch data packets belonging to each LSP to the protection tunnel in case of a failure in the nodes or links of the respective LSP.

According to the present invention there is provided in a ring communications network comprising a plurality of LSPs established between respective source and destination nodes through at least one respective intermediate node, a LSP protection mechanism comprising a mirror protection ring established over a protection transport medium for each LSP, and a switching mechanism operative to switch data packets belonging to each LSP to the mirror protection tunnel in case of a failure in the nodes or links of the respective LSP.

### BRIEF DESCRIPTION OF THE DRAWINGS

The invention is herein described, by way of example only, with reference to the accompanying drawings, wherein:

FIG. 1 is an exemplary diagram of an optical fiber ring network utilizing a MPLS protocol;

FIG. 2 is an example for a misconnection and mismerge situation in ring based label-switching networks;

FIG. 3 is an illustration of a ring topology network used for demonstrating the principles of the transparent protection mechanism in accordance with an embodiment of this invention;

FIG. 4 is an illustration of a ring topology network used for demonstrating the principles of the tunnel protection mechanism in accordance with an embodiment of this invention;

FIG. 5 is an illustration a of ring topology network used for demonstrating the principles of the mirror protection mechanism in accordance with an embodiment of this invention; and

FIG. 6 shows illustrations of labels' tables configured according to the various protection mechanisms provided by this invention.

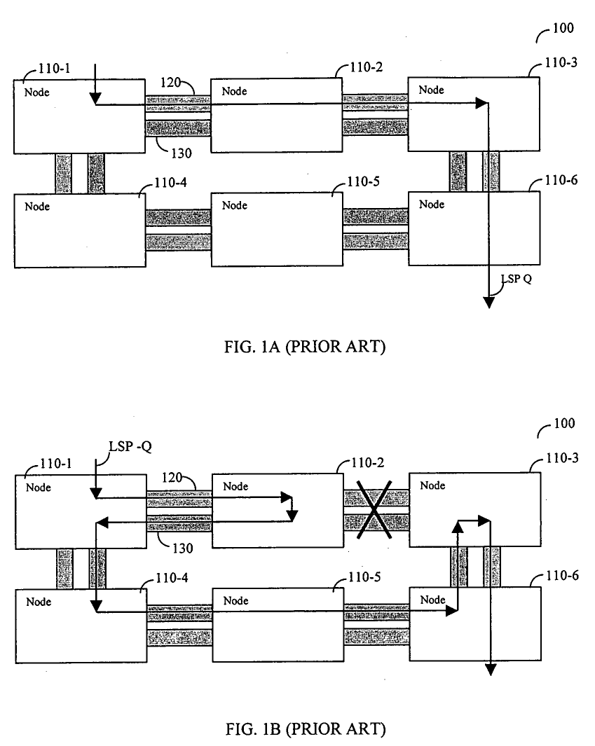

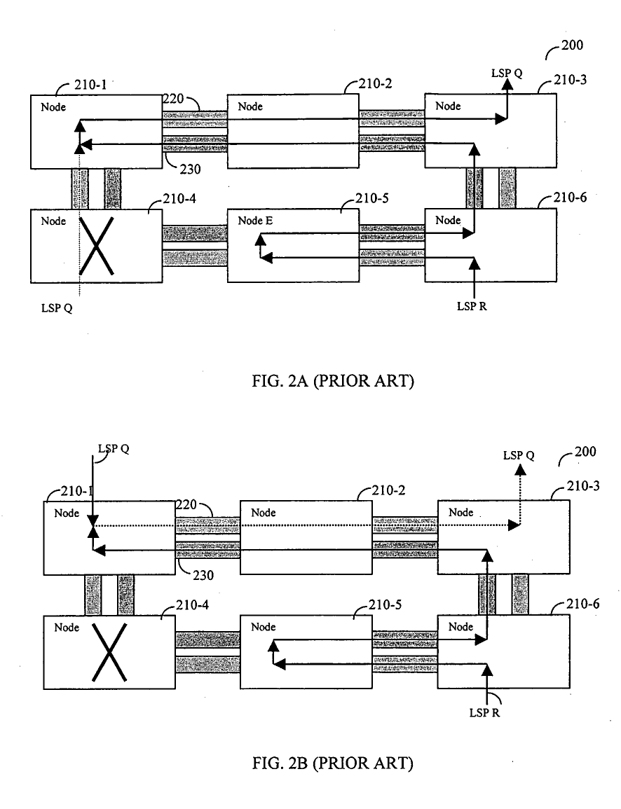

### DETAILED DESCRIPTION OF THE PREFERRED EMBODIMENTS

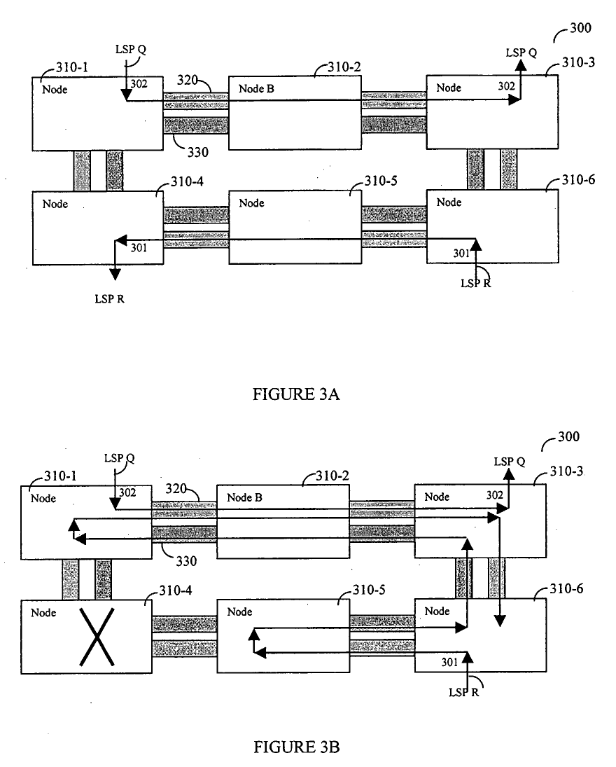

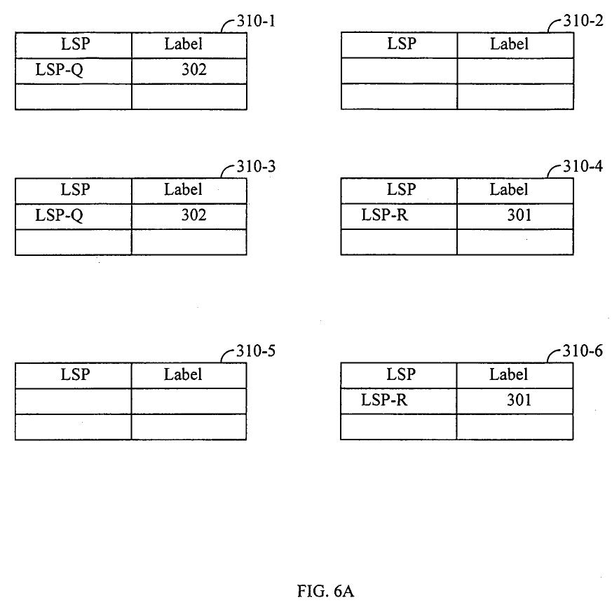

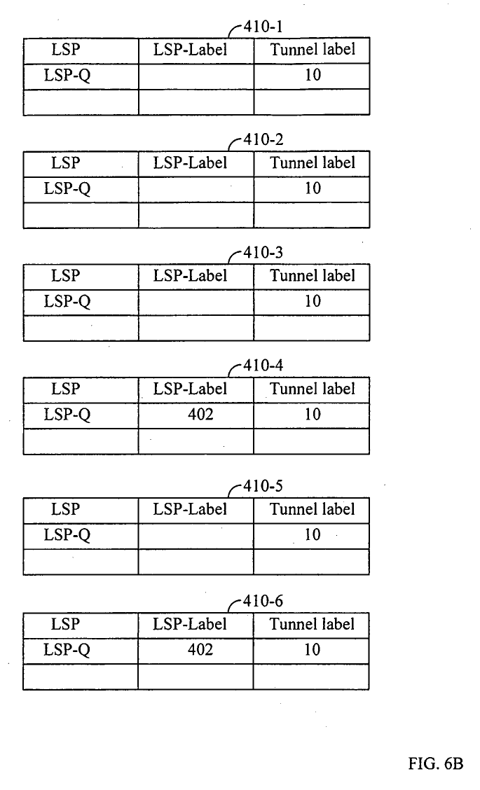

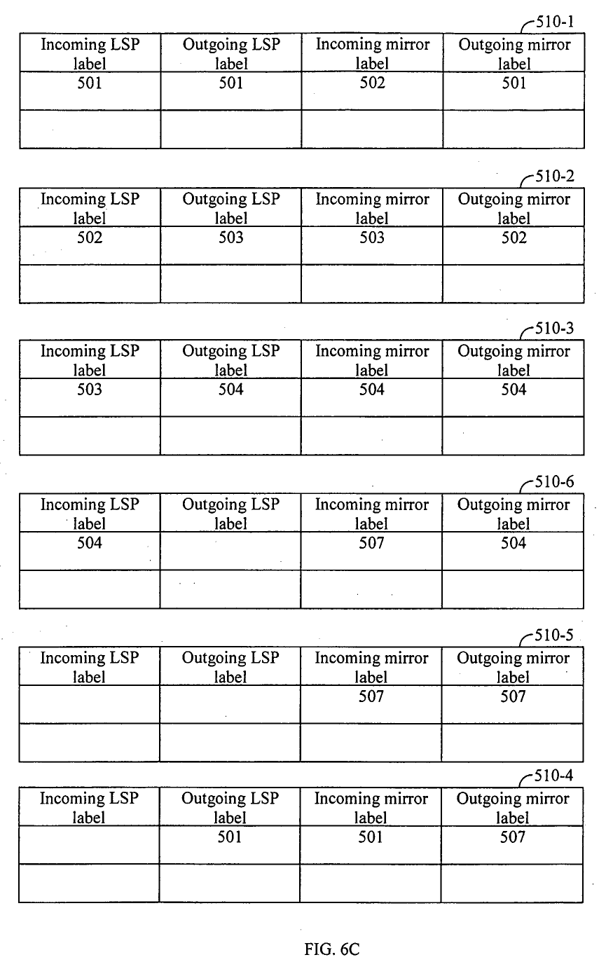

FIG. 3A shows a ring topology network 300 used for demonstrating the principles of the transparent protection mechanism, in accordance with an embodiment of this invention. Network 300 is an exemplary MPLS network that includes six network nodes 310-1 through 310-6 connected to a working transport medium 320 and a protection transport medium 330. That is, medium 320 carries working traffic and medium 330 carries protection traffic. Each of nodes 310 is capable of tunneling labeled packets between the other nodes of network 300. A node 310 includes a labels' table (see. FIG. 6) that maintains exclusive LSP labels assigned for the LSPs established in network 300. The content of a labels' table in the protection direction may be empty in one or more of nodes 310. Transport media 320 and 330 may be, but are not limited to, optical fibers, electric cores, wireless communication media, etc.

The transparent protection mechanism is based on the ability of the nodes to forward packets with unknown labels to the ring instead of discarding them. Assignment of an exclusive LSP label for each LSP established in network 300 solves the problem of misconnection and mismerge. Specifically, each LSP is uniquely identified with its own label. The exclusive label is not swapped by nodes 310 along the LSP and cannot be used for any other LSP at any node 310 on both working and protection paths. For each packet to be transmitted over a LSP, an exclusive LSP label is added by the source node of the LSP. As an example, a LSP ‘R’ provided in FIG. 3A is established between a source node 310-6 and a destination node 310-4 through a node 310-5. For example, the exclusive LSP label ‘301’ is appended to packets transmitted over LSP ‘R’ by node 310-6, and the exclusive LSP label ‘302’ is appended to packets transmitted over LSP ‘Q’ by node 310-1. In addition, to allow the operation of the transparent protection mechanism, nodes 310 are set to be transparent for unknown labels. Namely, each intermediate node of a LSP is configured to transmit packets including unknown labels, rather than discard them. An intermediate node is part of a LSP, but is not a source or destination node, for example, node 310-5 is an intermediate node of LSP ‘R’.

FIG. 6A shows a non-limiting example of the labels' tables of nodes 310 configured to protect LSP ‘R’ and LSP ‘Q’ in network 300. As can be noted, the tables of nodes 310-6 and 310-4 include the exclusive label 301 assigned to LSP ‘R’ and the tables of nodes 310-1 and 310-3 include an exclusive LSP label 302 assigned to LSP ‘Q’. The tables of nodes 310-2 and 310-5 are left empty. In order to allow the configuration of the labels' table and the nodes 310 to transparently pass traffic to be discarded, each of nodes 310 preferably includes a configuration mechanism (not shown). The configuration mechanism is adapted to operate in conjunction with a network management system (NMS) or a signaling protocol.

Switching to protection transport medium 330 is performed by the neighbor node (immediately following, also referred to as a “second” node) of a failed node. In addition, the traffic addressed to the failed node is discarded at the source node once the source node receives the traffic back from the working path. An example is shown FIG. 3B, where a failure is detected at node 310-4 which is the destination node of LSP ‘R’. A failure of a link that is utilized by a working LSP may include a fiber cut or an unacceptable degradation in the quality of service, such as an unacceptably high bit error rate (BER) or latency. Failures can be detected by any technique known in the art and the specific failure detection technique used is not critical to the invention. In such a case, the LSP ‘R’ working traffic ought to be discarded. The protection mechanism wraps the traffic to protection transport medium 330 at node 310-5. The traffic is transferred over protection transport medium 330 to node 310-1 by transparently passing through nodes 310-6, 310-3, and 310-2. Node 310-1 is a neighbor node of failed node 310-4 from the opposite direction on the ring, hence node 310-1 wraps the traffic back to working transport medium 320. The traffic is transmitted over working transport medium 320 to node 310-6, being transparently passed through nodes 310-2 and 310-3. Since the packets of the traffic received at node 310-6 include the exclusive LSP label ‘301’, these packets are discarded by node 310-6. The inventors further envision implementations-in which packets are discarded at a switching node, i.e., a node that wraps the traffic to the working transport medium (e.g., node 310-1). In such implementations, a switching node discards packets with labels that are not included in the labels' table of this switching node. In one implementation of the transparent mechanism, a labels' table of an intermediate node may be set with the labels of all the LSPs established in network 300. For instance, the labels' tables of nodes 310-1, 310-2, and 310-5 may include LSP label ‘301’ and may be configured to pass packets contains this label. Note that the labels' tables of the source and destination nodes of each LSP include the exclusive label of the LSP.

In accordance with an embodiment of this invention, extra traffic can be transmitted over network 300. Extra traffic refers to traffic carried over protection transport medium 330, if there is sufficient bandwidth that is not used for transporting either the protection traffic or the working traffic. In this embodiment, extra traffic can be carried over protection transport medium 330 using an exclusive label. If a failure occurs, the extra traffic is discarded at the first switching node, i.e., at the node that wraps the traffic to protecting transport medium (e.g., node 310-5). Note that the extra traffic is discarded in order to save bandwidth for working traffic on protection medium 330.

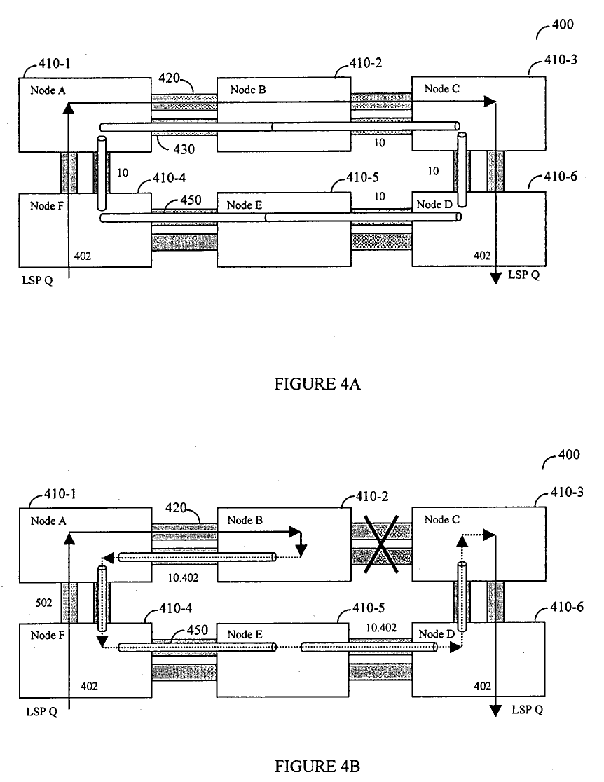

FIG. 4A shows an illustration of a ring network 400 used for demonstrating the principles of a protection tunnel mechanism, in accordance with an embodiment of this invention. Network 400 is a ring based label-switching network, e.g., a MPLS network that includes six network nodes 410-1 through 410-6 connected to a working transport medium 420 and a protection transport medium 430. Each of nodes 410 is capable of tunneling labeled packets between the other nodes and includes a labels' table. The labels' table includes tunnel labels to be used when switching to a protection mode and may further include exclusive LSP labels of the LSPs defined in network 400. Specifically, the protection tunnel mechanism transfers working traffic through a protection tunnel 450 when a failure is detected. Protection tunnel 450 is created over protection transport medium 430 and passes through all nodes 410, i.e., the protection tunnel is a closed loop. A protection tunnel is established for each LSP to be protected in network 400. A tunnel label is assigned for each protection tunnel. For example, protection tunnel 450 is identified by tunnel label ‘10’. The tunnel label is different from the exclusive label that identifies a LSP. In particular, the intermediate nodes are not required to maintain the exclusive LSP labels, but only the tunnel labels. FIG. 6B shows a non-limiting example of the labels' tables of nodes 410 configured to protect LSP ‘Q’ in network 400. As seen, each of the labels' tables of nodes 410-1 through 410-6 includes a tunnel label 10. In addition, the tables of nodes 410-4 and 410-6 include an exclusive LSP label 402.

Nodes 410 are configured to transparently transfer packets with a specified tunnel label transmitted over the protection tunnel. For example, nodes 410 transfer packets with tunnel label 10 transmitted over protection tunnel 450. Packets are sent to protection tunnel 450 by means of label stacking. Generally, as well known in the art, a labeled packet may carry many labels organized as a last in, first out (LIFO) stack. A detailed description of the label stacking mechanism may be found in http://www.ietf.org/rfc/rfc3032.txt, which is incorporated herein by reference. At each node 410, a label may be pushed onto the stack or popped from the stack. Packet processing is always based on the top label. At the beginning of protection tunnel 450, a node (e.g., node 410-2) assigns the tunnel label ‘10’ to packets by pushing the label onto the stack of each packet. At the end of protection tunnel 450, another node (e.g., node 410-6) pops the top element from the label stack, revealing the inner label. Here, tunnel label stacking is performed at nodes that wrap packets from or to protection transport medium 430.

The LSP ‘Q’ provided in FIG. 4A is established between a source node 410-4 and a destination node 410-6 through nodes 410-1, 410-2, and 410-3. The exclusive label associated with LSP ‘Q’ is ‘402’. If a failure is detected in working transport medium 420, the working traffic is wrapped to protection tunnel 450 and transferred over transport medium 430. An example is shown in FIG. 4B, where a failure is detected in a segment of working transport medium 420 that links nodes 410-2 and 410-3. Packets from source node 410-4 are transferred to nodes 410-1 and 410-2 over working transport medium 420. At node 420-2, packets are wrapped to protection tunnel 450 by pushing the tunnel label assigned to this tunnel (e.g., the label having the value ‘10’) to each incoming packet. Now, each packet is transferred over protection transport medium 430 to node 410-3 through nodes 410-1, 410-4, 410-5, and 410-6. Each packet that travels through protection tunnel 450 includes at least two labels: the exclusive label ‘402’ and the tunnel label ‘10’. Node 410-3 wraps the packets to working transport medium 420 and sends them to the destination nodes 410-6 of LSP ‘Q’, while the tunnel label is removed. For simplicity, the protection tunnel mechanism is described herein with only one protection tunnel. However, it would be appreciated by a person skilled in the art that there are implementations in which multiple protection tunnels may be established over network 400. Each such tunnel may serve a different class of service. As described above in greater detail, the use of labels (both tunnel and LSP labels) allows to avoid situations of misconnection and mismerge as packets are discarded only at the source node.

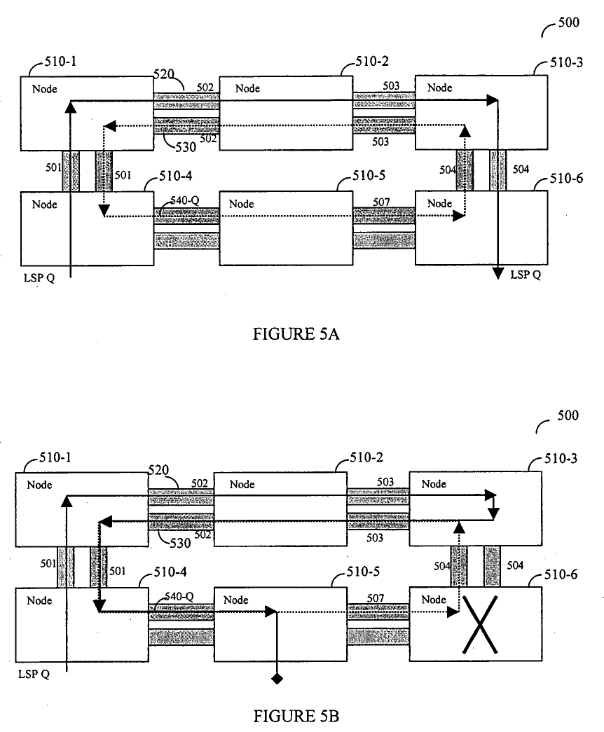

FIG. 5A shows an illustration of a ring topology network 500 used for demonstrating the principles of a mirror protection mechanism, in accordance with an embodiment of this invention. Network 500 may be a MPLS network that includes six network nodes 510-1 through 510-6 connected to a working transport medium 520 and a protection transport medium 530. Namely, transport medium 520 carries working traffic while transport medium 530 carries protection traffic. The mirror protection mechanism is used in MPLS networks where the uniqueness of a label (e.g. a MPLS label) per LSP cannot be achieved. Particularly, in such networks each node 510 that receives a labeled packet removes the incoming label, attaches an appropriate outgoing label to the packet, and forwards the packet to the next nodes along the LSP.

The mirror protection mechanism transfers working traffic through a mirror protection ring when a failure is detected. Specifically, for each LSP defined in network 500, a mirror protection ring has to be configured as an opposite closed-loop LSP. As shown in FIG. 5A, a mirror protection ring 540-Q is configured for LSP ‘Q’. The mirror labels of the mirror protection ring can be identical to the labels of the LSP along the working path. For example, labels ‘501’, ‘502’, ‘503’, and ‘504’ are the labels of the LSP ‘Q’ as well as of the mirror protection ring 540-Q assigned for this path. In network segments where the mirror protection ring and the LSP do not overlap, labels are arbitrarily specified. For example, node 510-5 is not part of LSP ‘Q’, hence the incoming and the outgoing labels (e.g., a label ‘507’ shown in FIG. 5B) of node 510-5 on mirror protection ring 550 are arbitrarily selected.

FIG. 6C shows a non-limiting example of the labels' tables of nodes 510 configured to protect LSP ‘Q’ in network 500. As can be noted, each table of each of the nodes 510-1 through 510-6 includes incoming and outgoing mirror labels in addition to the incoming and outgoing LSP labels. The mirror labels are identical to the LSP label, except for node 510-5.

Packets sent with an arbitrary label to a failed node, which is the destination node of LSP. are discarded. This is performed to avoid situations of misconnection and mismerge. As an example, referring to FIG. 5B, a failure is detected in the destination node 510-6 of LSP ‘Q’. Packets are wrapped at node 510-3 to mirror protection ring 540-Q and transmitted to 510-5 through nodes 510-3, 510-2, 510-1, and 510-5. Packets received at node 510-5 over the mirror protection ring 540-Q are discarded.

It should be appreciated by a person skilled in the art that the protection mechanisms described herein can be utilized to operate in both unidirectional ring networks and bidirectional ring networks.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

While the invention has been described with respect to a limited number of embodiments, it will be appreciated that many variations, modifications and other applications of the invention may be made.

1-33. (canceled)

34. In a ring communications network, a method for protecting a label switched path (LSP) established between a source node and a destination node through at least one intermediate node comprising the steps of:
i. creating at least one closed-loop protection tunnel over a protection transport medium;
ii. assigning a tunnel label for each protection tunnel; and
iii. upon detecting a failure, switching data packets to the protection tunnel.

35. The method of claim 34, wherein the assigning of the tunnel label includes configuring each node in the ring network to transparently transfer the data packets over the protection tunnel.

36. The method of claim 34, wherein the switching of the data packet packets to the protection tunnel is performed by means of a label stacking mechanism.

37. The method of claim 34, wherein the switching of the data packets includes the steps of wrapping the data packets to the protection tunnel at a first node adjacent to a location of the failure, and wherein the method further comprises the steps of:
i. wrapping the data packets to a working transport medium at a second node adjacent to a location of the failure; and
ii. transmitting the wrapped data packets to the destination node.

38. The method of claim 37, further comprising the step of discarding the data packets if the failure is situated in the destination node.

39. The method of claim 37, wherein the data packets are discarded at a node selected from the group consisting of the source node and the second node adjacent to a location of the failure.

40. The method of claim 34, wherein the first node and the second node are located on opposite directions of the ring network.

41. The method of claim 34, wherein the ring network utilizes at least a label switching protocol for transferring data packets over the ring communications network.

42. The method of claim 34, wherein the label switching protocol is at least a multi-protocol label switching (MPLS) protocol.

43. The method of claim 34, wherein the ring network is selected from the group consisting of a unidirectional ring network and a bidirectional ring network.

44. In a ring communications network, a method for protecting a label switched path (LSP) established between a source node and a destination node through at least one intermediate node in a ring network comprising the steps of:
i. creating a mirror protection ring for the LSP over a protection transport medium; and
ii. upon detecting a failure, switching the data packets belonging to the LSP to the respective mirror protection ring. iii. configuring each overlapped node of the mirror protection ring with a label of the LSP; and
iv. configuring each non-overlapped node of the mirror protection ring with an arbitrary label.

45. The method of claim 44, wherein the overlapped node is part of the LSP and the mirror protection ring.

46. In a ring communications network comprising a plurality of label switching paths LSPs) established between respective source and destination nodes through at least one respective intermediate node, a LSP protection mechanism comprising:
a. at least one closed-loop protection tunnel established over a protection transport medium;
b. a respective tunnel label assigned to each protection tunnel; and
c. a switching mechanism operative to switch data packets to the protection tunnel in case of a failure in the nodes or links of the respective LSP.
